(19) United States
(12) Patent Application Publication
(10) Pub. No.: US 2026/0296469 A1
(43) Pub. Date: Oct. 1, 2026

(54) DRIVING ASSISTANCE DEVICE, DRIVING ASSISTANCE METHOD, AND PROGRAM

(71) Applicant: HONDA MOTOR CO., LTD., Tokyo (JP)

(72) Inventors: Takuma Kobayashi, Tokyo (JP); Mineyuki Yoshida, Tokyo (JP); Yuko Sugimura, Tokyo (JP); Shunsuke Michita, Tokyo (JP)

(21) Appl. No.: 19/551,650

(22) Filed: Feb. 27, 2026

(30) Foreign Application Priority Data
Mar. 31, 2025 (JP) 2025-057654

(51) Int. Cl. B60W 50/12; B60W 10/04; B60W 10/18; B60W 10/20; B60W 50/08; B60W 50/14

(52) U.S. Cl. CPC B60W 50/12; B60W 10/04; B60W 10/18; B60W 10/20; B60W 50/082; B60W 50/14; B60W 2050/143; B60W 2540/30

(57) ABSTRACT

A driving assistance device includes: a recognition unit that recognizes a situation around a vehicle; a mode determination unit that is included in a driving control unit which controls one or both of acceleration/deceleration and steering of the vehicle and determines a driving mode of causing the vehicle to travel by any of a plurality of driving assistances having a different task imposed on a driver of the vehicle; a determination unit that is included in the driving control unit and determines whether or not the driver is responding to the imposed task; and an execution unit that is included in the driving control unit, issues an alarm when the determination unit determines that the driver is not responding to the imposed task, and executes a control in which the driving mode determined by the mode determination unit is switched to a driving mode to which a function restriction is applied based on a travel situation around the vehicle recognized by the recognition unit and a presence or absence of a change in a behavior of the driver after the alarm is issued.

### CROSS-REFERENCE TO RELATED APPLICATION

Priority is claimed on Japanese Patent Application No. 2025-057654, filed on Mar. 31, 2025, the contents of which are incorporated herein by reference.

### BACKGROUND

### FIELD OF THE INVENTION

The present invention relates to a driving assistance device, a driving assistance method, and a program.

### BACKGROUND

In recent years, there have been increasing attempts to provide access to a sustainable transportation system that takes into consideration the most vulnerable traffic participants. For this realization, research and development efforts are focused on further improving the safety and convenience of transportation through research and development related to driving assistance techniques. With the spread of autonomous driving/advanced driving assistance systems, realization of a safe, secure and comfortable mobility society is expected. However, it has been pointed out that the number of drivers who overestimate a safe driving assistance function or abuse or misuse the safe driving assistance function is increasing, and measures for causing a driver to use the safe driving assistance function correctly are required.

For example, Japanese Unexamined Patent Application, First Publication No. 2024-019189 discloses that, as a technique for performing autonomous driving further safely, when a driving intervention level required for a driver in accordance with an automation level becomes frequently insufficient, a penalty such as a function restriction is imposed on the driver. Further, Japanese Pat No. 7578052 discloses that, as a technique for improving an inappropriate behavior of a driver in a period of time of traveling by an autonomous driving function, when an inappropriate behavior by a driver is detected, the use of the autonomous driving function of the next time by the driver is restricted.

### SUMMARY

Preventing the damage caused by an incorrect operation or an abuse of the autonomous driving function is an extremely important technical matter for realizing a safe, secure, and comfortable mobility society. In order to realize a safe, secure, and comfortable mobility society, further attempts are required which prevent the abuse and the misuse of the autonomous driving function.

The present application aims at providing a driving assistance device, a driving assistance method, and a program capable of further preventing an abuse and a misuse of an autonomous driving function compared to the related art. Further, the present application contributes to the development of a sustainable transportation system.

A driving assistance device according to a first aspect of the present invention includes: a recognition unit that recognizes a situation around a vehicle; a driving control unit that controls one or both of acceleration/deceleration and steering of the vehicle; a mode determination unit that determines a driving mode of causing the vehicle to travel by any of a plurality of driving assistances having a different task imposed on a driver of the vehicle; a determination unit that determines whether or not the driver is responding to the imposed task; and an execution unit that issues an alarm when the determination unit determines that the driver is not responding to the imposed task and executes a control in which the driving mode determined by the mode determination unit is switched to the driving mode to which a function restriction is applied based on a travel situation around the vehicle recognized by the recognition unit and a presence or absence of a change in a behavior of the driver after the alarm is issued.

A second aspect of the present invention is the driving assistance device according to a first aspect described above, wherein the execution unit may limit a number of the driving assistances as the function restriction.

A third aspect of the present invention is the driving assistance device according to the first or second aspect described above, wherein the determination unit may determine whether or not the behavior of the driver is corrected after the alarm is issued by the execution unit.

A fourth aspect of the present invention is the driving assistance device according to the first or second aspect described above, wherein the execution unit may impose a restriction preferentially from a comfort function among the plurality of driving assistances.

A fifth aspect of the present invention is the driving assistance device according to the first or second aspect described above which may include: a storage unit that stores information relating to the behavior of the driver when the alarm is issued; and a specifying unit that specifies a safe driving assistance function caused by an alarm issuance based on the information relating to the behavior of the driver stored in the storage unit, wherein the execution unit may impose a restriction on the function specified by the specifying unit.

A sixth aspect of the present invention is the driving assistance device according to the second aspect described above, wherein the function restriction may differentiate a control timing or a control amount of at least one safe driving assistance function from a normal control timing or a normal control amount.

A seventh aspect of the present invention is the driving assistance device according to the second aspect described above, wherein the function restriction may be released by positioning a shift lever to a non-travel range or a reverse range.

A driving assistance method according to an eighth aspect of the present invention includes: by way of a computer, recognizing a situation around a vehicle; controlling one or both of acceleration/deceleration and steering of the vehicle; determining a driving mode of causing the vehicle to travel by any of a plurality of driving assistances having a different task imposed on a driver of the vehicle; determining whether or not the driver is responding to the imposed task; issuing an alarm when it is determined that the driver is not responding to the imposed task; and executing a control in which the determined driving mode is switched to the driving mode to which a function restriction is applied based on a travel situation around the vehicle and a presence or absence of a change in a behavior of the driver after the alarm is issued.

A ninth aspect of the present invention is a computer-readable non-transitory storage medium that stores a program which causes a computer to: recognize a situation around a vehicle; control one or both of acceleration/deceleration and steering of the vehicle; determine a driving mode of causing the vehicle to travel by any of a plurality of driving assistances having a different task imposed on a driver of the vehicle; determine whether or not the driver is responding to the imposed task; issue an alarm when it is determined that the driver is not responding to the imposed task; and execute control in which the determined driving mode is switched to the driving mode to which a function restriction is applied based on a travel situation around the vehicle and a presence or absence of a change in a behavior of the driver after the alarm is issued.

According to the aspect of the present invention, it is possible to provide a driving assistance device, a driving assistance method, and a program capable of further preventing an abuse and a misuse of an autonomous driving function compared to the related art.

### BRIEF DESCRIPTION OF THE DRAWINGS

FIG. 1 is a system configuration view of a vehicle system including a driving assistance device according to an embodiment of the present invention.

FIG. 2 is a block diagram showing a detailed configuration of a first control unit and a second control unit in the driving assistance device.

FIG. 3 is a view showing an example of a correspondence relationship among a driving mode, a control state of a self-vehicle, and a task.

FIG. 4 is a flowchart showing an operation of the driving assistance device according to the embodiment of the present invention.

FIG. 5 is a schematic view showing an operation of the driving assistance device according to the driving assistance device.

### DESCRIPTION OF EMBODIMENTS

Hereinafter, embodiments of a driving assistance device, a driving assistance method, and a program of the present invention will be described with reference to the drawings.

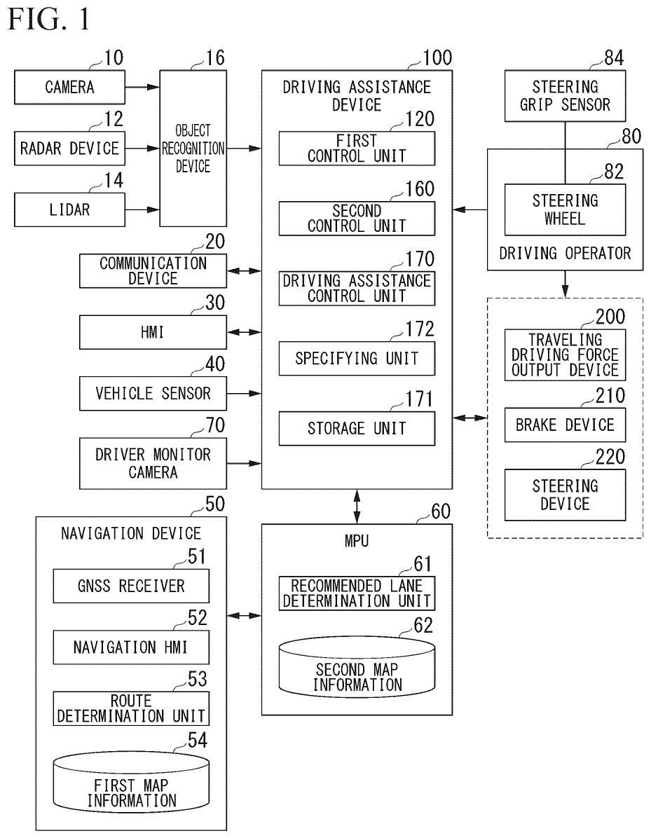

FIG. 1 is a system configuration view of a vehicle system including a driving assistance device 100 according to the present embodiment. A vehicle on which the vehicle system is mounted is, for example, a vehicle such as a two-wheeled vehicle, a three-wheeled vehicle, or a four-wheeled vehicle, and a drive source thereof is an internal combustion engine such as a diesel engine or a gasoline engine, an electric motor, or a combination of these. The electric motor operates by using electric power generated by a generator connected to the internal combustion engine or discharge electric power of secondary batteries or fuel cells.

The vehicle system includes, for example, a camera 10, a radar device 12, a LIDAR (Light Detection and Ranging) 14, an object recognition device 16, a communication device 20, an HMI (Human Machine Interface) 30, a vehicle sensor 40, a navigation device 50, an MPU (Map Positioning Unit) 60, a driver monitor camera 70, a driving operator 80, a driving assistance device 100, a traveling drive force output device 200, a brake device 210, and a steering device 220.

These devices and apparatuses are connected to each other by a multiplex communication line such as a CAN (Controller Area Network) communication line, a serial communication line, a wireless communication network, or the like. The configuration shown in FIG. 1 is merely an example, and part of the configuration may be omitted, or another configuration may be added.

The camera 10 is, for example, a digital camera that uses a solid-state imaging element such as a CCD (Charge Coupled Device) or a CMOS (Complementary Metal Oxide Semiconductor). The camera 10 is attached to an arbitrary place of a vehicle on which the vehicle system is mounted. When an image of the front is captured, the camera 10 is attached to an upper part of a front windshield, a back surface of a rear-view mirror, and the like. The camera 10 periodically and repeatedly captures, for example, an image of a periphery of the vehicle. The camera 10 may be a stereo camera.

The radar device 12 radiates radio waves such as millimeter waves to the periphery of the vehicle and detects radio waves (reflected waves) reflected by an object to detect at least a position (distance and direction) of the object. The radar device 12 is attached to an arbitrary place of the vehicle. The radar device 12 may detect the position and a speed of the object by a FM-CW (Frequency Modulated Continuous Wave) method.

The LIDAR 14 irradiates the periphery of the vehicle with light (or an electromagnetic wave having a wavelength close to that of light) and measures scattered light. The LIDAR 14 detects a distance to a target on the basis of a time from light emission to light reception. The emitted light is, for example, a pulsed laser beam. The LIDAR 14 is attached to an arbitrary place of the vehicle.

The object recognition device 16 performs sensor fusion processing on a result of detection by some or all of the camera 10, the radar device 12, and the LIDAR 14 and recognizes the position, type, speed, and the like of an object. The object recognition device 16 outputs a result of recognition to the driving assistance device 100. The object recognition device 16 may output the result of detection by the camera 10, the radar device 12, and the LIDAR 14 to the driving assistance device 100 as they are. The object recognition device 16 may be omitted from the vehicle system.

The communication device 20 communicates with other vehicles present in the periphery of the vehicle by using, for example, a cellular network, a Wi-Fi network, Bluetooth (a registered trademark), DSRC (Dedicated Short-Range Communication), or the like, or communicates with various server devices via a wireless base station.

The HMI 30 presents various types of information to an occupant of the vehicle and receives an input operation by the occupant. The HMI 30 includes various display devices, a speaker, a buzzer, a touch panel, a switch, a key, and the like.

The vehicle sensor 40 includes a vehicle speed sensor that detects a speed of the vehicle, an acceleration sensor that detects an acceleration, a yaw rate sensor that detects an angular speed around a vertical axis, an azimuth sensor that detects a direction of the vehicle, and the like.

The navigation device 50 includes, for example, a GNSS (Global Navigation Satellite System) receiver 51, a navigation HMI 52, and a route determination unit 53. The navigation device 50 holds first map information 54 in a storage device such as an HDD (Hard Disk Drive) or a flash memory.

The GNSS receiver 51 specifies the position of the vehicle based on a signal received from a GNSS satellite. The position of the vehicle may be identified or complemented by an INS (Inertial Navigation System) using an output of the vehicle sensor 40.

The navigation HMI 52 includes a display device, a speaker, a touch panel, a key, and the like. The navigation HMI 52 may be partially or entirely shared with the HMI 30 described above.

The route determination unit 53 determines, for example, a route (hereinafter, a route on a map) from the position of the vehicle (or an arbitrary position that is input) specified by the GNSS receiver 51 to a destination that is input by the occupant using the navigation HMI 52 with reference to the first map information 54.

The first map information 54 is, for example, information in which the shape of a road (road shape) is expressed by a link indicating a road and nodes connected by a link. The first map information 54 may include a road curvature, POI (Point of Interest) information, and the like. A route on a map is output to an MPU 60.

The navigation device 50 may perform route guidance using the navigation HMI 52 based on the route on a map. The navigation device 50 may be realized by, for example, a function of a terminal device such as a smartphone or a tablet terminal owned by the occupant. The navigation device 50 may transmit a current position and a destination to a navigation server via the communication device 20 and acquire a route equivalent to the route on a map from the navigation server.

The MPU 60 includes, for example, a recommended lane determination unit 61 and holds second map information 62 in a storage device such as an HDD or a flash memory.

The recommended lane determination unit 61 divides the route on a map provided from the navigation device 50 into a plurality of blocks (for example, divides every 100 [m] in a vehicle traveling direction) and determines a recommended lane for each block with reference to the second map information 62. The recommended lane determination unit 61 determines which numbered lane from the left to drive. When a branch place is present on the route on a map, the recommended lane determination unit 61 determines a recommended lane such that the vehicle can travel on a reasonable route for proceeding to a branch destination.

The second map information 62 is map information with higher accuracy than the first map information 54. The second map information 62 includes, for example, information on a center of a lane, information on a boundary of the lane, and the like. Further, the second map information 62 may include road information, traffic regulation information, address information (addresses/zip codes), facility information, telephone number information, information of a prohibition zone in which a mode A or a mode B described later is prohibited, and the like. The second map information 62 may be updated at any time by the communication device 20 communicating with another device.

The driver monitor camera 70 is, for example, a digital camera that uses a solid-state imaging element such as a CCD or a CMOS. The driver monitor camera 70 is attached to an arbitrary place in the vehicle at a position and an orientation in which the head of an occupant (hereinafter, a driver) seated on a driver's seat of the vehicle can be imaged from the front (in an orientation in which the face of the driver is imaged). For example, the driver monitor camera 70 is attached to an upper part of a display device which is provided on a middle portion of an instrument panel of the vehicle M.

The driving operator 80 includes, for example, an accelerator pedal, a brake pedal, a shift lever, and other operators in addition to a steering wheel 82. A sensor that detects the amount of operation or a presence or absence of an operation is attached to the driving operator 80, and a result of detection is output to the driving assistance device 100, or some or all of the traveling drive force output device 200, the brake device 210, and the steering device 220.

The operator does not necessarily have an annular shape but may have a form such as an odd-shaped steering, a joystick, or a button. A steering grip sensor 84 is attached to the steering wheel 82.

The steering grip sensor 84 is implemented by a capacitance sensor or the like and outputs, to the driving assistance device 100, a signal which can detect whether or not the driver grips the steering wheel 82 (which means that the driver is in contact with the steering wheel 82 in a state in which a force can be applied).

The driving assistance device 100 includes, for example, a first control unit 120, a second control unit 160, a driving assistance control unit 170, a storage unit 171, and a specifying unit 172. Each of the first control unit 120 and the second control unit 160 is realized by, for example, a hardware processor such as a CPU (Central Processing Unit) executing a program (software).

Further, some or all of these components may be realized by hardware (a circuit unit; including circuitry) such as an LSI (Large Scale Integration), an ASIC (Application Specific Integrated Circuit), an FPGA (Field-Programmable Gate Array), a GPU (Graphics Processing Unit), or an SOC (System on Chip) or may be realized by software and hardware in cooperation.

A program may be stored in advance in a storage device (a storage device including a non-transitory storage medium) such as an HDD or a flash memory of the driving assistance device 100, or may be stored in a detachable storage medium such as a DVD or a CD-ROM and installed in the HDD or the flash memory of the driving assistance device 100 by the storage medium (non-transitory storage medium) being attached to a drive device.

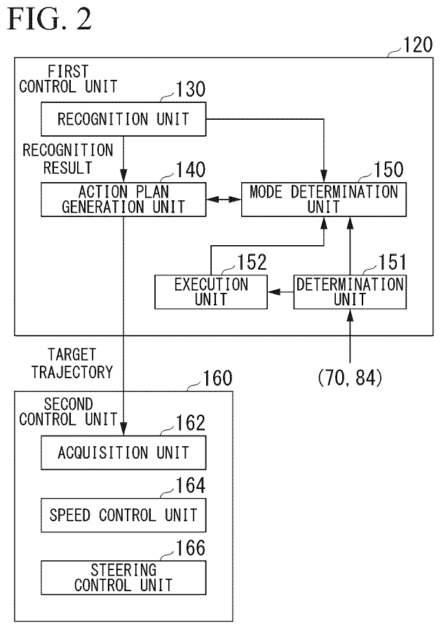

As shown in FIG. 2, the first control unit 120 includes, for example, a recognition unit 130, an action plan generation unit 140, a mode determination unit 150, a determination unit 151, and an execution unit 152. The first control unit 120 realizes, for example, a function by AI (Artificial Intelligence) and a function by a predetermined model in parallel. For example, a function of “recognizing an intersection” may be realized by a comprehensive evaluation of executing both of recognition of an intersection by deep learning or the like and recognition based on a predetermined condition (there are signals, road signs, and the like for which pattern matching is available) in parallel, and scoring both recognitions. Thereby, reliability of the autonomous driving is ensured.

The recognition unit 130 recognizes the situation around the vehicle based on information input from the camera 10, the radar device 12, and the LIDAR 14 via the object recognition device 16. That is, the recognition unit 130 recognizes a state such as the position, the speed, and the acceleration of an object that is present around the vehicle.

For example, the position of an object is recognized as a position on absolute coordinates with a representative point (a center of gravity, a center of a drive axis, or the like) of the vehicle as an origin and is used for a control. The position of an object may be represented by a representative point such as the center of gravity or a corner of the object or may be represented by an area. The “state” of an object may include the acceleration or jerk of the object, or a “behavior state” (for example, whether or not the lane change is being performed or is about to be performed).

Further, the recognition unit 130 recognizes, for example, a lane (travel lane) in which the vehicle is traveling, a road lane marking, or the like.

The recognition unit 130 recognizes the position and an orientation of the vehicle with respect to a travel lane when the travel lane is recognized. The recognition unit 130 may recognize, for example, a deviation of a reference point of the vehicle from a center of a lane and an angle formed with respect to a line connecting the center of the lane in the traveling direction of the vehicle as the relative position and the relative orientation of the vehicle with respect to the travel lane. Instead, the recognition unit 130 may recognize the position or the like of the reference point of the vehicle with respect to any side end (a road lane marking or a road boundary) of the travel lane as the relative position of the vehicle with respect to the travel lane.

The action plan generation unit 140 generates a target trajectory along which the vehicle will automatically travel (without depending on the operation of the driver) in the future such that the vehicle travels in the recommended lane determined by the recommended lane determination unit 61 in principle and such that the vehicle avoids approaching an object (excluding an object such as a road lane marking, a road sign, a manhole, or the like over which the vehicle can pass) recognized by the recognition unit 130.

For example, the recognition unit 130 sets a risk region centered on an object that outputs the state, and a risk is set in the risk region by the recognition unit 130 as an index value indicating the degree to which the vehicle should not approach.

The action plan generation unit 140 generates a target trajectory such that the vehicle will not travel through a point where the risk is equal to or more than a predetermined value and travels in the recognized travel lane. Since the object includes a moving object, the risk distribution is not one for each control cycle but is set for a plurality of time points in the future in consideration of the future position of the object predicted based on the speed of the object.

For example, the target trajectory is expressed as a sequence of points (trajectory points) to be reached by the vehicle. The trajectory point is a point to be reached by the vehicle for each predetermined travel distance (for example, about several [m]) along a road, and separately from this, a target speed and a target acceleration for each predetermined sampling time (for example, about several decimal number [sec]) are generated as part of the target trajectory. Further, the trajectory point may be a position to be reached by the vehicle at a corresponding sampling time for each predetermined sampling time. In this case, information of the target speed and the target acceleration is expressed by an interval of the trajectory points.

The action plan generation unit 140 may set an event of autonomous driving when a target trajectory is generated. The event of autonomous driving includes a constant-speed traveling event, a low-speed following traveling event, a lane change event, a branching event, a merging event, a takeover event, and the like. The action plan generation unit 140 generates a target trajectory in accordance with an activated event.

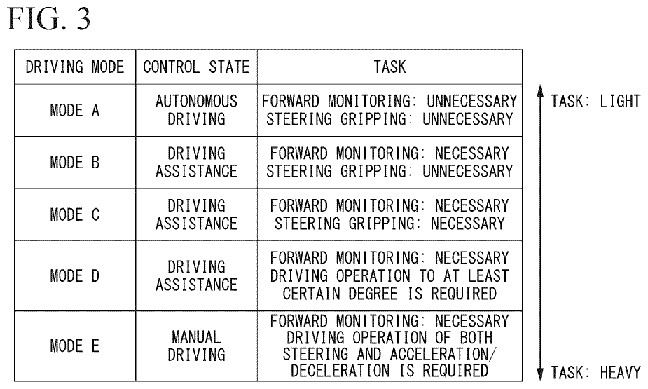

The mode determination unit 150 determines a driving mode of causing the vehicle to travel by any of a plurality of driving assistance having a different task imposed on the driver of the vehicle. The task is, for example, the forward monitoring of the driver, the gripping of the steering wheel 82, or the like. FIG. 3 is a view showing an example of a correspondence relationship among a driving mode, a control state of a vehicle, and a task. The driving mode of the vehicle includes, for example, five modes from a mode A to a mode E. The control state, that is, the automation degree of the driving control of the vehicle is highest in the mode A, is then decreased in the order of a mode B, a mode C, and a mode D, and is lowest in the mode E.

Conversely, the task imposed on the driver is lightest in the mode A, then becomes heavier in the order of the mode B, the mode C, and the mode D and is heaviest in the mode E. Since the control state is not the autonomous driving in the modes D and E, the driving assistance device 100 is responsible for ending a control relating to the autonomous driving and shifting the control state to the driving assistance or a manual driving. Hereinafter, examples of the contents of each driving mode are shown.

In the mode A, the state becomes an autonomous driving state, and neither the forward monitoring nor the gripping of the steering wheel 82 (steering gripping in the drawing) is imposed on the driver. However, even in the mode A, the driver is required to be in an orientation in which the driving can quickly shift to the manual driving in response to a request from the system dominated by the driving assistance device 100. The mode A and the autonomous driving may be included in the driving assistance. That is, the driving assistance may include the autonomous driving and the driving assistance in the mode B or less.

The autonomous driving means that all of the steering, acceleration, and deceleration are controlled independently of the driver's operation. The term “forward” means a space in the traveling direction of the vehicle visually recognized through the front windshield. The mode A is, for example, a driving mode that can be executed when the vehicle is traveling at a predetermined speed (for example, about 50 km/h) or less on a dedicated road for automobiles such as a highway, and a condition in which the preceding vehicle to be followed is present or the like is satisfied. The mode A may be also referred to as a TJP (Traffic Jam Pilot). When this condition is not satisfied, the mode determination unit 150 changes the driving mode of the vehicle to the mode B.

In the mode B, the state becomes a driving assistance state, and a task (hereinafter, referred to as forward monitoring) of monitoring the forward direction of the vehicle is imposed on the driver, but a task of gripping the steering wheel 82 is not imposed on the driver.

In the mode C, the state becomes the driving assistance state, and the task of forward monitoring and the task of gripping the steering wheel 82 are imposed on the driver. The mode D is a driving mode in which regarding at least one of the steering and the acceleration/deceleration of the vehicle, a driving operation by the driver to a certain degree is required.

For example, in the mode D, driving assistance such as ACC (Adaptive Cruise Control) and LKAS (Lane Keeping Assist System) is performed. In the mode E, the state becomes a manual driving state in which a driving operation by the driver is required for both steering and acceleration/deceleration. In both of the mode D and the mode E, the task of monitoring the forward direction of the vehicle is imposed on the driver.

Here, the driving mode in the present embodiment is not limited to the examples shown in FIG. 3 and may be defined by other definitions. For example, among driving modes that require both the forward monitoring and the steering gripping, there may be a mode in which a threshold value for determining that the steering is gripped is loose and a mode in which the threshold value is strict. Further, the driving assistance by LKAS (Lane Keeping Assistance System), ACC (Adaptive Cruise Control), ALC (Auto Lane Changing), RDM (Road Departure Mitigation), or CMBS (Collision Mitigation Braking System) may be also employed as the driving mode. Each driving assistance will be described later.

More specifically, the driving mode may be defined such that, in one driving mode, it is enough that either the left hand or the right hand of the driver is in contact with the steering wheel 82, but in another driving mode in which a task imposed on the driver is heavier than the one driving mode, the driver needs to hold the steering wheel 82 with both hands at a strength equal to or more than a threshold value. Other driving modes having a different heaviness of the task imposed on the driver may be defined in any manner.

The driving assistance device 100 executes an auto lane changing (ALC) in accordance with the driving mode. The auto lane changing includes an auto lane changing (1) by a system request and an auto lane changing (2) by a driver request.

The auto lane changing (1) includes an auto lane changing for overtaking, which is performed when the speed of the preceding vehicle is smaller than the speed of the self-vehicle by a reference value or more, and an auto lane changing (auto lane changing due to the change of the recommended lane) for proceeding toward the destination.

The auto lane changing (2) causes the vehicle to change the lane toward an operation direction in a case where a turn signal is operated by the driver when a condition relating to the speed, the position relationship with surrounding vehicles, and the like is satisfied.

For example, in the mode A, the driving assistance device 100 does not execute any of the auto lane changing (1) and the auto lane changing (2). For example, in the modes B and C, the driving assistance device 100 executes both of the auto lane changing (1) and the auto lane changing (2). For example, in the mode D, the driving assistance device 100 does not execute the auto lane changing (1) but executes the auto lane changing (2). In the mode E, for example, neither the auto lane changing (1) nor the auto lane changing (2) is performed.

The mode determination unit 150 determines a driving mode that causes the vehicle to travel by any of a plurality of driving assistances having a different task imposed on the driver of the vehicle. The mode determination unit 150 may change the driving mode of the vehicle to a driving mode in which the task is heavier when the task relating to the driving mode (current driving mode) determined by the mode determination unit 105 is not performed by the driver.

For example, in the case where the driver is in an orientation in which the driver cannot shift to manual driving in response to a request from the system in the mode A (for example, in the case where the driver continues to look aside at the outside of an allowable area or in the case where a presage indicating that the driving becomes difficult is detected), the mode determination unit 150 may perform a control of prompting the driver to shift to manual driving by using the HMI 30, and stopping the autonomous driving by causing the vehicle to move close to the road shoulder and gradually stopping the vehicle if the driver does not respond. After stopping the autonomous driving, the self-vehicle is in the state of the mode D or E, and the vehicle can be started by the manual driving of the driver. Hereinafter, the same applies to “stopping of the autonomous driving”.

When the driver is not monitoring the forward direction in the mode B, the mode determination unit 150 may perform a control of prompting the driver to perform the forward monitoring by using the HMI 30, and stopping the autonomous driving by causing the vehicle to move close to the road shoulder and gradually stopping the vehicle if the driver does not respond. When the driver is not monitoring the forward direction or is not gripping the steering wheel 82 in the mode C, the mode determination unit 150 may perform a control of prompting the driver to perform the forward monitoring and/or grip the steering wheel 82 by using the HMI 30, and stopping the autonomous driving by causing the vehicle to move close to the road shoulder and gradually stopping the vehicle if the driver does not respond.

The ACC (acceleration/deceleration control) is a control in which a vehicle automatically controls the speed of the vehicle to follow the preceding vehicle while keeping the distance between the vehicle and the preceding vehicle constant. When the preceding vehicle is not present, the speed of the vehicle is controlled such that the vehicle travels at a preset speed.

The LKAS (lane keeping control) controls the steering device 220 such that the vehicle does not deviate from the travel lane. For example, the driving assistance control unit 170 controls the steering device 220 such that the vehicle travels at the center or near the center of the travel lane. Hereinafter, this control may be referred to as a “lane keeping control”. The driving assistance control unit 170 executes a hands-on lane keeping control and a hands-off lane keeping control.

The hands-on lane keeping control is a control executed in a state (a state where the steering grip sensor 84 is detecting the gripping of the steering wheel 82) where the driver is gripping the steering wheel 82. A condition in which the hands-on lane keeping control can be executed is looser than a condition in which the hands-off lane keeping control can be executed. For example, the hands-on lane keeping control is executed on the condition that the speed of the vehicle is equal to or more than a predetermined speed and the driver is monitoring the forward direction.

The hands-off lane keeping control is a control executed in a state (a state where the steering grip sensor 84 is not detecting the gripping of the steering wheel 82) where the driver is not gripping the steering wheel 82. The hands-off lane keeping can be executed, for example, when the following condition is satisfied. The condition is that the speed of the vehicle is equal to or more than a predetermined speed, that the vehicle is traveling on a predetermined road (for example, a road or a type of road on which it is set in advance that the hands-off lane keeping control can be executed), and that the driver is monitoring the forward direction. When the driver is monitoring the forward direction, the hands-off lane keeping control is executed, and when the driver is not monitoring the forward direction, the hands-off lane keeping control is not executed or is stopped.

The condition described above in which the hands-on lane keeping control and the hands-off lane keeping control can be executed is an example and may include other conditions (for example, the vehicle is following the preceding vehicle), or part of the condition may be omitted. It is enough that the condition in which the hands-on lane keeping control can be executed is looser than the condition in which the hands-off lane keeping can be executed (it is enough that the condition in which the hands-off lane keeping control can be executed is stricter than the condition in which the hands-on lane keeping can be executed).

The RDM is a control of performing a notification control to the driver when the vehicle deviates from the travel lane, performing a reaction force control that applies a reaction force to an operation of the steering wheel 82 by the driver in a direction in which the vehicle deviates from the travel lane, and performing a steering control such that the vehicle moves in the center direction of the travel lane.

The CMBS is a control that assists collision avoidance and damage reduction by warning the driver by a display, an alarm, or the like to call attention to the driver when the vehicle may collide with an obstacle (another vehicle or a pedestrian) in the vicinity and by executing at least one of a steering control and an acceleration/deceleration control when the vehicle further approaches the obstacle.

The determination unit 151 determines whether or not the driver is responding to the imposed task based on an image of the driver monitor camera 70 and a detection result of the steering grip sensor 84. That is, the determination unit 151 monitors the state of driver for a mode change in the mode determination unit 150 and determines whether or not the state of the driver is a state of responding to the task.

For example, the determination unit 151 analyzes the image captured by the driver monitor camera 70, performs an orientation estimation process, and determines whether or not the driver is in an orientation in which the driver cannot shift to the manual driving in response to a request from the system. Further, the determination unit 151 analyzes the image captured by the driver monitor camera 70, performs a line-of-sight estimation process, and determines whether or not the driver is monitoring the forward direction. The determination unit 151 determines whether or not the driver is gripping the steering wheel 82 based on a detection result of the steering grip sensor 84. Further, the determination unit 151 determines whether or not the behavior of the driver is corrected after the alarm is issued by the execution unit 152 described later.

The execution unit 152 issues an alarm when the determination unit 151 determines that the driver is not responding to the imposed task. Further, the execution unit 152 executes a control in which the current driving mode determined by the mode determination unit 150 is switched to the driving mode to which a function restriction is applied on the basis of a travel situation around the vehicle recognized by the recognition unit and a presence or absence of a change in a behavior of the driver after the alarm is issued.

Further, when the determination unit 151 determines that the driver is not responding to the imposed task, the execution unit 152 imposes a restriction on a function specified by the specifying unit 172 described later. The function restriction by the execution unit 152 differentiates a control timing or a control amount of at least one safe driving assistance function from a normal control timing or a normal control amount (described later).

The function restriction may be a restriction that limits the number of provided driving assistances among a plurality of driving assistances (described later). Further, the function restriction may be a restriction of imposing a restriction preferentially from a comfort function among the plurality of driving assistances (described later). Such a function restriction is released by the driver positioning the shift lever of the vehicle to a non-travel range or a reverse range.

The second control unit 160 controls the traveling drive force output device 200, the brake device 210, and the steering device 220 such that the vehicle passes through a target trajectory generated by the action plan generation unit 140 at a scheduled time.

The second control unit 160 includes, for example, an acquisition unit 162, a speed control unit 164, and a steering control unit 166 as shown in FIG. 2. The acquisition unit 162 acquires information on a target trajectory (trajectory points) generated by the action plan generation unit 140 and stores the information in a memory (not shown). The speed control unit 164 controls the traveling drive force output device 200 or the brake device 210 based on a speed element associated with the target trajectory stored in the memory. The steering control unit 166 controls the steering device 220 in accordance with a degree of bending of the target trajectory stored in the memory. The process of the speed control unit 164 and the steering control unit 166 is realized by, for example, a combination of a feedforward control and a feedback control. As an example, the steering control unit 166 executes the combination of a feedforward control in accordance with a curvature of a road in front of the vehicle and a feedback control based on a deviation from the target trajectory.

When the driving assistance control unit 170 performs the driving assistance of the vehicle, that is, when the mode determination unit 150 determines any of the mode B, the mode C, and the mode D as the driving mode, the driving assistance control unit 170 controls the traveling drive force output device 200, the brake device 210, and the steering device 220 and thereby controls one or both of the acceleration/deceleration and the steering of the vehicle.

The storage unit 171 stores information relating to the behavior of the driver when the alarm is issued. The information relating to the behavior of the driver stored in the storage unit 171 is, for example, information relating to an operation of the driver to the vehicle. The storage unit 171 provides the specifying unit 172 with the information relating to the behavior of the driver in response to a read request input from the specifying unit 172.

The specifying unit 172 specifies a safe driving assistance function caused by the alarm issuance based on the information relating to the behavior of the driver acquired from the storage unit 171. That is, the specifying unit 172 specifies which one of a plurality of safe driving assistance functions that constitute the vehicle system is the cause of the alarm issued by the execution unit 152 described above.

The traveling drive force output device 200 outputs a traveling drive force (torque) for the vehicle to travel to a drive wheel. The traveling drive force output device 200 includes, for example, a combination of an internal combustion engine, a motor, a transmission, and the like, and an ECU (Electronic Control Unit) that controls these elements. The ECU controls the configuration described above in accordance with information input from the second control unit 160 or information input from the driving operator 80.

The brake device 210 includes, for example, a brake caliper, a cylinder that transmits a hydraulic pressure to the brake caliper, an electric motor that generates a hydraulic pressure in the cylinder, and a brake ECU. The brake ECU controls the electric motor in accordance with the information input from the second control unit 160 or the information input from the driving operator 80 and outputs a brake torque in accordance with a braking operation to each wheel.

The brake device 210 may include a mechanism of transmitting a hydraulic pressure generated by an operation of a brake pedal included in the driving operator 80 to the cylinder via a master cylinder as a backup. The brake device 210 is not limited to the configuration described above and may be an electronically controlled hydraulic brake device that controls an actuator in accordance with the information input from the second control unit 160 to transmit the hydraulic pressure of the master cylinder to the cylinder.

The steering device 220 includes, for example, a steering ECU and an electric motor.

The electric motor changes, for example, a direction of a steering wheel by applying a force to a rack and pinion mechanism. The steering ECU drives the electric motor in accordance with the information input from the second control unit 160 or the information input from the driving operator 80 and changes the direction of the steering wheel.

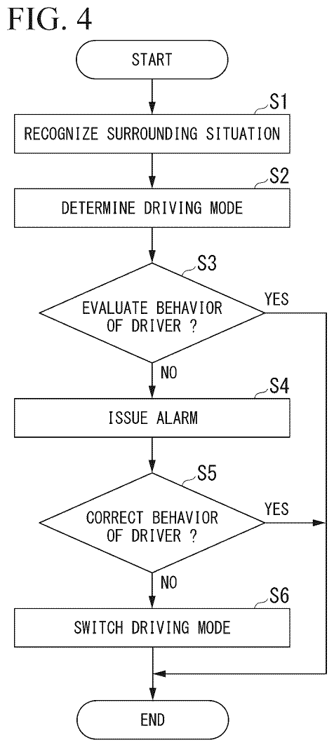

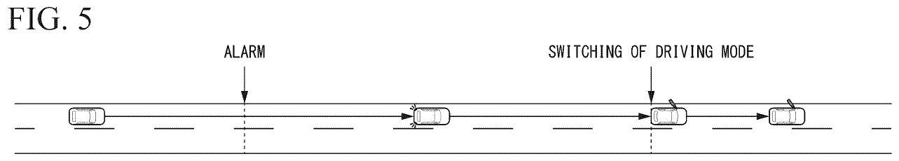

Next, an operation of the driving assistance device 100, a driving assistance method, and a program according to the present embodiment will be described with reference to a flowchart of FIG. 4 and a schematic view of FIG. 5.

When the driving assistance device 100 starts the driving assistance, the recognition unit 130 of the first control unit 120 recognizes the situation around the vehicle based on information input from the camera 10, the radar device 12, and the LIDAR 14 via the object recognition device 16 (Step S1).

As shown in FIG. 3, the mode determination unit 150 of the first control unit 120 determines one driving mode from a plurality of driving modes (modes A to E) in which the driving state of the vehicle and the task are associated with each other (Step S2). For example, when the control state is the driving assistance, the mode determination unit 150 determines any of the mode B, the mode C, and the mode D as the driving mode. Step S2 may be performed prior to Step S1.

When the driving mode is the mode B, the mode C, or the mode D, the driving assistance control unit 170 controls the traveling drive force output device 200, the brake device 210, and the steering device 220 and thereby causes the vehicle to perform driving assistance traveling. For example, when the driving mode is set to the mode B, the mode C, or the mode D, the driving assistance control unit 170 starts the driving assistance control.

The determination unit 151 of the first control unit 120 determines whether or not the driver is responding to the imposed task in the driving mode (Step S3). That is, the determination unit 151 determines whether or not the behavior of the driver is responding to the task imposed in the driving mode based on an image of the driver monitor camera 70 and a detection result of the steering grip sensor 84.

When the determination unit 151 determines that the driver is not responding to the imposed task, the execution unit 152 of the first control unit 120 issues an alarm in the traveling of the vehicle as shown in FIG. 5 (Step S4). Then, the determination unit 151 determines whether or not the behavior of the driver is corrected such that the behavior of the driver is responding to the task after the alarm is issued by the execution unit 152 (Step S5).

When the determination unit 151 determines that the behavior of the driver is not corrected, the execution unit 152 causes the mode determination unit 150 to perform switching of the driving mode based on the presence or absence of the change in the behavior of the driver after the alarm is issued that is determined by the determination unit 151 and the travel situation around the vehicle that is recognized by the recognition unit 130 of the first control unit 120 (Step S6).

The mode determination unit 150 switches the driving mode that has already been determined to a driving mode in which the function is further restricted as shown in FIG. 5 on the basis of a control command input from the execution unit 152. Among the mode B, the mode C, and the mode D in which the control state is the driving assistance, the mode C is a driving mode in which the function is further restricted than the mode B. Further, the mode D is a driving mode in which the function is further restricted than the mode C.

For example, during the driving assistance by the mode B, when the determination unit 151 determines that the driver is not responding to the task imposed in the mode B, the execution unit 152 outputs, to the mode determination unit 150, a control command of switching the mode B (current driving mode) that has already been determined to the mode C.

As a result, the mode determination unit 150 switches the mode B (current driving mode) to the mode C.

Further, during the driving assistance by the mode C, when the determination unit 151 determines that the driver is not responding to the task imposed in the mode C, the execution unit 152 outputs, to the mode determination unit 150, a control command of switching the mode C (current driving mode) that has already been determined to the mode D. As a result, the mode determination unit 150 switches the mode C (current driving mode) to the mode D.

For example, in the mode A, when the determination unit 151 determines that the driver is not responding to the task imposed in the mode A, the execution unit 152 may output, to the mode determination unit 150, a control command of switching the mode A (current driving mode) that has already been determined to the mode B. As a result, the mode determination unit 150 switches the mode A (current driving mode) to the mode B. The task in the mode A is that the driver is in an orientation in which the driver cannot shift to the manual driving in response to a request from the system (for example, continuing to look aside at the outside of an allowable area from the image of the driver monitor camera 70, detecting a presage indicating that the driving becomes difficult, or the like).

Here, the execution unit 152 may limit the number of driving modes as a function restriction when the behavior of the driver is not responding to the task imposed in the current driving mode. When limiting the driving mode, the execution unit 152 preferentially imposes a restriction from a function that is comfortable for the driver among the plurality of driving modes.

“Switching to a driving mode in which the function is further restricted” includes switching from a state in which the assistance of acceleration/deceleration, steering, or auto lane changing such as ACC, LKAS, or ALC is being performed (or a state in which the assistance can be performed) to a driving mode in which a part of the function is turned off. Further, turning off a part of the function described above is an example of limiting the number of driving modes as a function restriction. In this case, each of the functions is an example of the driving mode. The driving mode may include the RDM or CMBS described above. The part may include a plurality of functions (for example, a plurality of functions that are grouped). In the driving modes, the required task may be the same as each other or be different from each other. For example, the task may be part or all of the forward monitoring, the gripping of the steering wheel 82, and an orientation in which the driver can switch the driving or may include other tasks.

For example, in the storage unit 171, priority of a comfort degree is assigned to the assistance functions such as ACC, LKAS, and ALC. The execution unit 152 imposes a restriction preferentially from a comfort assistance function having higher priority. For example, the priority is higher in the order of ACC, LKAS, and ALC. If the assist function is turned off from the ACC, acceleration of the vehicle is prevented, and therefore, it can be expected that the behavior of the driver is corrected. For example, the priority is higher in the order of LKAS, ACC, and ALC. If the assist function is turned off from the LKAS, the vehicle moves away from the center of the lane, and therefore, it can be expected that the behavior of the driver is corrected.

Further, the function restriction executed by the execution unit 152 may differentiate the control timing or the control amount of at least one safe driving assistance function from the normal control timing or the normal control amount. Further, the function restriction described above may be released by positioning the shift lever to the non-travel range or the reverse range.

As described above, the driving assistance device 100 according to the present embodiment includes: a recognition unit 130 that recognizes a situation around a vehicle; a driving control unit (driving assistance control unit 170) that controls one or both of acceleration/deceleration and steering of the vehicle; a mode determination unit 150 that determines a driving mode of causing the vehicle to travel by any of a plurality of driving assistances having a different task imposed on a driver of the vehicle; a determination unit 151 that determines whether or not the driver is responding to the imposed task; and an execution unit 152 that issues an alarm when the determination unit 151 determines that the driver is not responding to the imposed task and executes a control in which the driving mode determined by the mode determination unit 150 is switched to a driving mode to which a function restriction is applied based on a travel situation around the vehicle recognized by the recognition unit 130 and a presence or absence of a change in a behavior of the driver after the alarm is issued.

That is, according to the present embodiment, when the behavior is not corrected after attention is called by the alarm with respect to the abuse or the misuse of the driving assistance device, the penalty imposed on the driver in a step-by-step manner serves as a reminder of further prompting a change in the behavior, and therefore, it is possible to cause the driver to recognize a correct usage method of the autonomous driving (AD) / advanced driving assistance system (ADAS) again. Therefore, according to the present embodiment, it is possible to provide the driving assistance device 100 capable of further preventing the abuse and the misuse of the autonomous driving function compared to the related art.

Further, in the driving assistance device 100 according to the present embodiment, the execution unit 152 limits the number of driving modes as the function restriction. According to the present embodiment, in the restriction of the driving assistance function, not only part of a specific function is restricted, but also a plurality of driving assistances may be grouped, and the function restriction may be provided in a group unit that is provided.

Further, in the driving assistance device 100 according to the present embodiment, the determination unit 151 determines whether or not the behavior of the driver is corrected after the alarm is issued by the execution unit 152. According to the present embodiment, since the change in the behavior of the driver after attention is called by the alarm is determined, it is possible to further appropriately call attention (The determination is performed by monitoring the change in the behavior before and after the alarm issuance by a measurement device such as a driver monitor camera, a steering grip sensor, a load sensor).

Further, in the driving assistance device 100 according to the present embodiment, the execution unit 152 imposes a restriction preferentially from a comfort function among a plurality of driving modes. According to the present embodiment, since the function is restricted in priority from a comfort control (the hands-off function, ACC, or the like) among the plurality of assistance functions of the autonomous driving (AD)/advanced driving assistance system (ADAS), the comfort is impaired for the driver who misuses the function, and therefore, it is possible to cause the driver to recognize the misuse or the abuse at an early stage and further effectively prompt the change in the behavior.

Further, the driving assistance device 100 according to the present embodiment includes: a storage unit 171 that stores information relating to the behavior of the driver when the alarm is issued; and a specifying unit 172 that specifies a safe driving assistance function caused by an alarm issuance based on the information relating to the behavior of the driver stored in the storage unit 171, wherein the execution unit 152 imposes a restriction on the function specified by the specifying unit 172. According to the present embodiment, the action of the misuse or the abuse is stored in the storage unit, and by a statistical analysis thereof, a function frequently misused or abused is specified (regardless of a statistical analysis). By applying a restriction on the specified function, it is possible to further motivate the driver to change the driver's behavior.

For example, it can be specified that a task of forward monitoring is not being performed when the LKAS is being performed, or that a task of gripping of the steering wheel 82 is not being performed.

When the task is not performed to a predetermined degree or more, the execution unit 152 may impose a restriction (for example, a restriction for a predetermined period of time) on the use of the safe driving assistance function (driving mode) relating to the task.

In the example described above, the restriction is applied to the LKAS.

Further, in the driving assistance device 100 according to the present embodiment, the function restriction executed by the execution unit 152 differentiates a control timing or a control amount of at least one safe driving assistance function from a normal control timing or a normal control amount. According to the present embodiment, for a driver who ignores the alarm or a driver who does not respond to the calling of attention, for example, a control intervention timing may be advanced in the case of the collision mitigation braking (CMBS), and one or both of a control of reducing a steering return amount and a control in which a deceleration is made larger than a normal deceleration in the case of the road departure mitigation function (RDM) may be performed. In the case of the preceding vehicle following control (ACC), by intervening a control such as delaying of a response time of a required following speed, the fact that the function restriction is issued due to the misuse is transmitted to the driver as a sense of discomfort different from the alarm, and therefore, this helps to correct the behavior.

Further, in the driving assistance device 100 according to the present embodiment, the function restriction executed by the execution unit 152 is released by positioning a shift lever to a non-traveling range or a reverse range. According to the present embodiment, by causing a complicated operation to intentionally intervene in the cancellation of the function restriction, there is an effect of psychologically preventing the abuse and the misuse of the safe driving assistance function.

More specifically, when the driver operates the shift position to a P range, by the system (control unit) recognizing the driver change or that the driving is once stopped, the function restriction can be automatically released, and by performing a shift operation of the shift position for a predetermined time from a D range to an R range or an N range in which a drive output mode of the traveling drive force output device is largely switched, the function restriction can be automatically released.

A driving assistance method according to the present embodiment includes: recognizing a situation around a vehicle; controlling one or both of acceleration/deceleration and steering of the vehicle; determining a driving mode of causing the vehicle to travel by any of a plurality of driving assistances having a different task imposed on a driver of the vehicle; determining whether or not the driver is responding to the imposed task; issuing an alarm when it is determined that the driver is not responding to the imposed task; and executing a control in which the determined driving mode is switched to a driving mode to which a function restriction is applied based on a travel situation around the vehicle and a presence or absence of a change in a behavior of the driver after the alarm is issued. According to the present embodiment, it is possible to provide the driving assistance method capable of further preventing the abuse and the misuse of the autonomous driving function compared to the related art.

A program according to the present embodiment causes a computer to: recognize a situation around a vehicle; control one or both of acceleration/deceleration and steering of the vehicle; determine a driving mode of causing the vehicle to travel by any of a plurality of driving assistances having a different task imposed on a driver of the vehicle; determine whether or not the driver is responding to the imposed task; issue an alarm when it is determined that the driver is not responding to the imposed task; and execute a control in which the determined driving mode is switched to a driving mode to which a function restriction is applied based on a travel situation around the vehicle and a presence or absence of a change in a behavior of the driver after the alarm is issued. According to the present embodiment, it is possible to provide the program capable of further preventing the abuse and the misuse of the autonomous driving function compared to the related art.

Although the embodiment of the present invention has been described, the present invention is not limited to the embodiment described above. Various modifications and substitutions can be made without departing from the scope of the present invention. For example, the device configuration shown in FIG. 1 and FIG. 2 is merely an example of the present invention, and various modifications are conceivable.

What is claimed is:

1. A driving assistance device comprising:
a recognition unit that recognizes a situation around a vehicle;
a driving control unit that controls one or both of acceleration/deceleration and steering of the vehicle;
a mode determination unit that determines a driving mode of causing the vehicle to travel by any of a plurality of driving assistances having a different task imposed on a driver of the vehicle;
a determination unit that determines whether or not the driver is responding to the imposed task; and
an execution unit that issues an alarm when the determination unit determines that the driver is not responding to the imposed task and executes a control in which the driving mode determined by the mode determination unit is switched to the driving mode to which a function restriction is applied based on a travel situation around the vehicle recognized by the recognition unit and a presence or absence of a change in a behavior of the driver after the alarm is issued.

2. The driving assistance device according to claim 1,
wherein the execution unit limits a number of the driving assistances as the function restriction.

3. The driving assistance device according to claim 1,
wherein the determination unit determines whether or not the behavior of the driver is corrected after the alarm is issued by the execution unit.

4. The driving assistance device according to claim 1,
wherein the execution unit imposes a restriction preferentially from a comfort function among the plurality of driving assistances.

5. The driving assistance device according to claim 1, comprising:
a storage unit that stores information relating to the behavior of the driver when the alarm is issued; and
a specifying unit that specifies a safe driving assistance function caused by an alarm issuance based on the information relating to the behavior of the driver stored in the storage unit,
wherein the execution unit imposes a restriction on the function specified by the specifying unit.

6. The driving assistance device according to claim 2,
wherein the determination unit determines whether or not the behavior of the driver is corrected after the alarm is issued by the execution unit.

7. The driving assistance device according to claim 2,
wherein the execution unit imposes a restriction preferentially from a comfort function among the plurality of driving assistances.

8. The driving assistance device according to claim 2, comprising:
a storage unit that stores information relating to the behavior of the driver when the alarm is issued; and
a specifying unit that specifies a safe driving assistance function caused by an alarm issuance based on the information relating to the behavior of the driver stored in the storage unit,
wherein the execution unit imposes a restriction on the function specified by the specifying unit.

9. The driving assistance device according to claim 2,
wherein the function restriction differentiates a control timing or a control amount of at least one safe driving assistance function from a normal control timing or a normal control amount.

10. The driving assistance device according to claim 2,
wherein the function restriction is released by positioning a shift lever to a non-travel range or a reverse range.

11. A driving assistance method comprising:
by way of a computer,
recognizing a situation around a vehicle;
controlling one or both of acceleration/deceleration and steering of the vehicle;
determining a driving mode of causing the vehicle to travel by any of a plurality of driving assistances having a different task imposed on a driver of the vehicle;
determining whether or not the driver is responding to the imposed task;
issuing an alarm when it is determined that the driver is not responding to the imposed task; and
executing a control in which the determined driving mode is switched to the driving mode to which a function restriction is applied based on a travel situation around the vehicle and a presence or absence of a change in a behavior of the driver after the alarm is issued.

12. A computer-readable non-transitory storage medium that stores a program which causes a computer to:
recognize a situation around a vehicle;
control one or both of acceleration/deceleration and steering of the vehicle;
determine a driving mode of causing the vehicle to travel by any of a plurality of driving assistances having a different task imposed on a driver of the vehicle;
determine whether or not the driver is responding to the imposed task;
issue an alarm when it is determined that the driver is not responding to the imposed task; and
execute a control in which the determined driving mode is switched to the driving mode to which a function restriction is applied based on a travel situation around the vehicle and a presence or absence of a change in a behavior of the driver after the alarm is issued.
